(19) United States
(12) Patent Application Publication
(10) Pub. No.: US 2026/0045527 A1
(43) Pub. Date: Feb. 12, 2026

(54) AIRBOX STRUCTURE FOR VEHICLE

(71) Applicant: GM GLOBAL TECHNOLOGY OPERATIONS LLC, DETROIT, MI (US)

(72) Inventors: Bhaskara Kishore Chirravuri, Andhrapradesh (IN); Devendra Sankla, Bangaluru (IN); Jess Neely, New Hudson, MI (US); Ronald Miller, Bloomfield Hills, MI (US)

(21) Appl. No.: 18/795,657

(22) Filed: Aug. 6, 2024

(51) Int. Cl. H01M 8/04111; B01D 45/08; B60L 50/72; H01M 8/04082

(52) U.S. Cl. CPC H01M 8/04111; B01D 45/08; B60L 50/72; H01M 8/04201; H01M 2250/20

(57) ABSTRACT

An airbox for a fuel cell system includes an airbox body having an airflow inlet and an airflow outlet positioned therein. The airbox body includes at least one interior wall. An airbox cover is installed to the airbox body to enclose the airbox, and one or more liner plates are installed onto the at least one interior wall to prevent egress of debris from an interior of the airbox to an exterior of the airbox through the at least one interior wall.

### INTRODUCTION

The subject disclosure relates to vehicles, and more particularly to airbox structures for power systems of vehicles.

Fuel cell systems, such as those utilized in vehicle power systems often include a motorized turbocharger compressor (MTC) to boost air pressure and flow rates to meet those required for supplying the fuel cell stack. The MTC includes a rotor, such as an impeller that rotates at speeds in excess of 100,000 rpm. The art would well receive solutions to improve containment of debris from the MTC.

### SUMMARY

In one exemplary embodiment, an airbox for a fuel cell system includes an airbox body having an airbox inlet and an airbox outlet positioned therein. The airbox body includes at least one interior wall. An airbox cover is installed to the airbox body to enclose the airbox, and one or more liner plates are installed onto the at least one interior wall to prevent egress of debris from an interior of the airbox to an exterior of the airbox through the at least one interior wall.

In addition to one or more of the features described herein, the one or more liner plates are formed from a metallic material.

In addition to one or more of the features described herein, the metallic material is corrugated.

In addition to one or more of the features described herein, the one or more liner plates are secured to the at least one interior wall via a tab and slot arrangement.

In addition to one or more of the features described herein, at least one liner plate is installed to each of the airbox body and the airbox cover.

In addition to one or more of the features described herein, one or more of the airbox body and the airbox cover are formed from a plastic material.

In another exemplary embodiment, a fuel cell system includes a fuel cell stack containing at least one fuel cell and a motorized turbocharger compressor (MTC) system fluidly connected to the fuel cell stack to provide airflow for operation of the fuel cell stack. The MTC system includes a compressor housing including an air inlet and a compressed air outlet, and a rotor positioned in the compressor housing and driven to rotate about a rotor axis. The rotor includes a plurality of rotor blades. The MTC system further includes an airbox having an airbox inlet and an airbox outlet. The airbox outlet is connected to the air inlet via one or more airflow conduits. One or more liner plates are installed onto at least one interior wall of the airbox to prevent egress of debris from an interior of the airbox to an exterior of the airbox through the at least one interior wall.

In addition to one or more of the features described herein, the airbox includes an airbox body, and an airbox cover installed to the airbox body to enclose the airbox.

In addition to one or more of the features described herein, the one or more liner plates are installed to at least one of the airbox body and the airbox cover.

In addition to one or more of the features described herein, at least one liner plate is installed to each of the airbox body and the airbox cover.

In addition to one or more of the features described herein, the one or more liner plates are formed from a metallic material.

In addition to one or more of the features described herein, the metallic material is corrugated.

In addition to one or more of the features described herein, the one or more liner plates are secured to the at least one interior wall via a tab and slot arrangement.

In yet another exemplary embodiment, a vehicle includes a vehicle body, and a fuel cell system positioned in the vehicle body configured to provide power to one or more vehicle components. The fuel cell system includes a fuel cell stack containing at least one fuel cell and a motorized turbocharger compressor (MTC) system fluidly connected to the fuel cell stack to provide airflow for operation of the fuel cell stack. The MTC system includes a compressor housing including an air inlet and a compressed air outlet, and a rotor positioned in the compressor housing and driven to rotate about a rotor axis. The rotor includes a plurality of rotor blades. The MTC system further includes an airbox having an airbox inlet and an airbox outlet. The airbox outlet is connected to the air inlet via one or more airflow conduits. One or more liner plates are installed onto at least one interior wall of the airbox to prevent egress of debris from an interior of the airbox to an exterior of the airbox through the at least one interior wall.

In addition to one or more of the features described herein, the airbox includes an airbox body, and an airbox cover installed to the airbox body to enclose the airbox.

In addition to one or more of the features described herein, the one or more liner plates are installed to at least one of the airbox body and the airbox cover.

In addition to one or more of the features described herein, at least one liner plate is installed to each of the airbox body and the airbox cover.

In addition to one or more of the features described herein, the one or more liner plates are formed from a metallic material.

In addition to one or more of the features described herein, the metallic material is corrugated.

In addition to one or more of the features described herein, the one or more liner plates are secured to the at least one interior wall via a tab and slot arrangement.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of an embodiment of a vehicle;

FIG. 2 is a schematic illustration of an embodiment of a fuel cell system;

FIG. 3 is a cross-sectional view of an embodiment of a motorized turbocharger compressor (MTC) of a fuel cell system; and

FIG. 4 is a partially disassembled view of an embodiment of an airbox assembly.

### DETAILED DESCRIPTION

The following description is merely exemplary in nature and is not intended to limit the present disclosure, its application or uses. It should be understood that throughout the drawings, corresponding reference numerals indicate like or corresponding parts and features.

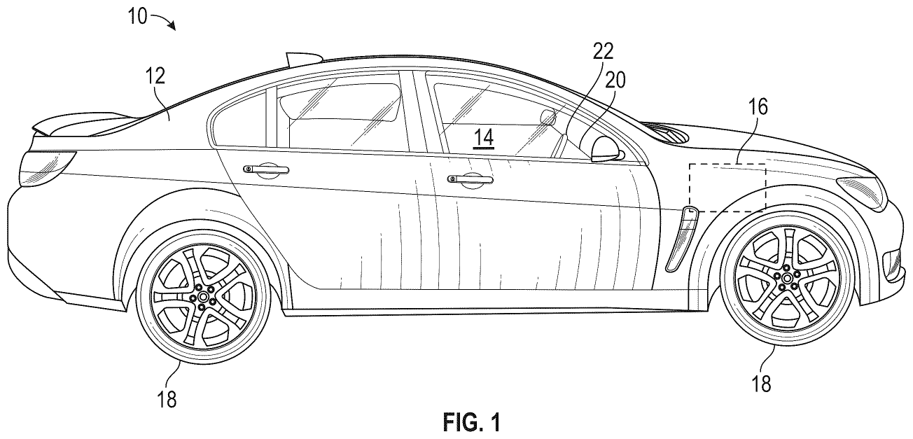

In accordance with an exemplary embodiment, illustrated in FIG. 1 is an embodiment of a vehicle 10. The vehicle 10 includes a vehicle body 12 defining a passenger compartment 14. The vehicle 10 further includes a powertrain 16 providing energy for propulsion and electrical power for operation of the vehicle systems. A plurality of wheels 18 are operably connected to the powertrain 16, and at least two of the wheels 18 are steerable. An instrument panel 20 is located in the passenger compartment 14, and a steering assembly 22 extends from the instrument panel 20 into the passenger compartment 14.

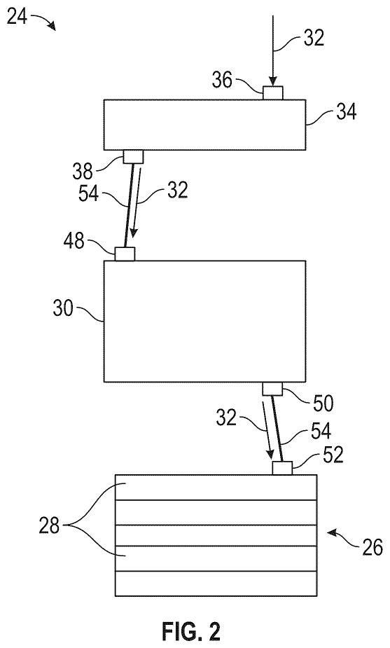

Referring now to FIG. 2, the powertrain 16 includes a fuel cell system 24 to generate electrical power for the vehicle 10. The fuel cell system 24 includes a fuel cell stack 26 having one or more fuel cells 28. The fuel cell stack 26 requires input of a flow of air at pressure and a high flow rate for satisfactory operation of the fuel cell stack 26. To provide adequate airflow, a motorized turbocharger compressor (MTC) 30 is operably connected to the fuel cell stack 26. The MTC 30 compresses airflow 32 received from an airbox 34 operably connected to the MTC 30. The airbox 34 is typically a plastic structure that may include one or more filters (not shown) or the like therein. The airbox 34 includes a plenum with an airbox inlet 36 and an airbox outlet 38 through which an airflow is supplied to the MTC 30. While the present disclosure describes the fuel cell system 24 in the context of the vehicle 10, one skilled in the art will readily appreciate that the present disclosure may be readily adapted to non-vehicle applications, such as stand-alone power generation systems, or integrated into many other mobile applications, such as boats, trains or the like.

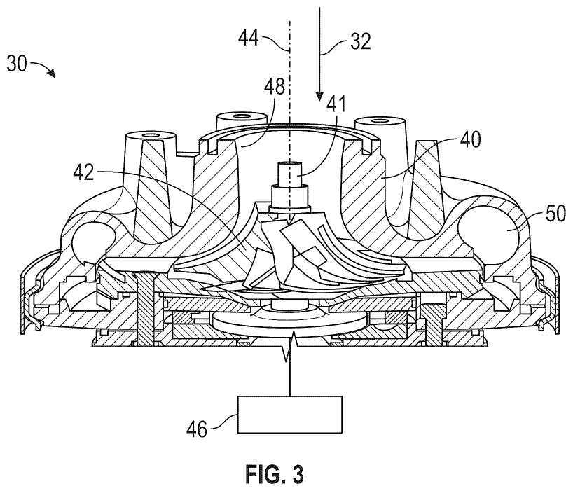

Referring now to FIG. 3, the MTC 30 includes an MTC housing 40 with a rotor 42, such as an impeller, disposed therein and driven to rotate on a rotor shaft 41 about a rotor axis 44. In some embodiments, the rotor 42 is driven by a motor 46, such as an electric motor, connected thereto. The MTC housing 40 includes an air inlet 48 through which airflow 32 is received from the airbox 34. The airflow 32 is compressed by the rotor 42 and is directed out of the housing via a compressed air outlet 50 to a fuel cell inlet 52 of the fuel cell stack 26 for use by the fuel cell stack 26. One or more airflow conduits 54 connect the airbox outlet 38 to the air inlet 48, and similarly connect the compressed air outlet 50 to the fuel cell inlet 52.

In some embodiments, the rotor 42 is driven at speeds of greater than 100,000 rpm. At such high speeds, malfunction of the MTC 30, and in particular the rotor 42 may generate debris moving with a large amount of kinetic energy, and in some embodiments at least a portion of this debris may exit the MTC housing 40 via the air inlet 38 and toward the airbox 34. Once inside the airbox 34, it is desired to contain the debris therein.

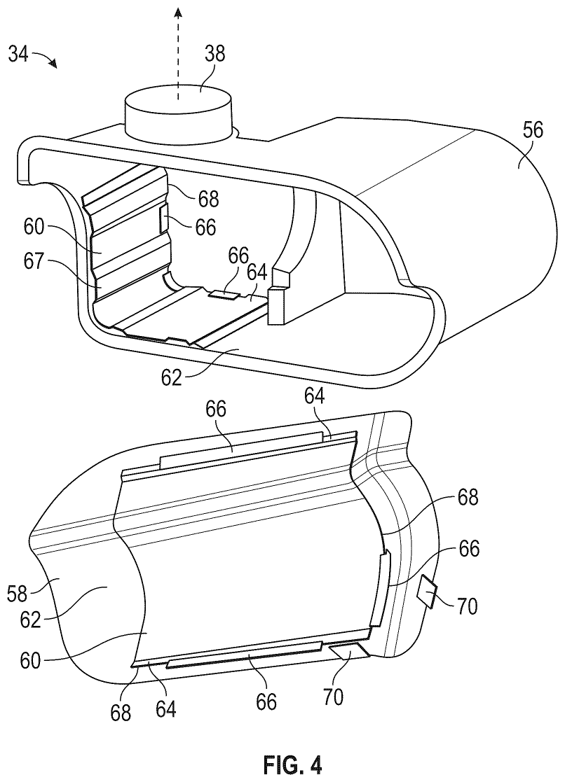

Referring now to FIG. 4, in some embodiments the airbox 34 is a plastic structure and in some embodiments includes an airbox body 56 and an airbox cover 58 secured to the airbox body 56 by, for example, one or more clips, fasteners, adhesives or the like. In the alternative, the airbox cover 58 may be permanently attached to the airbox body 56 by welding or the like. In some embodiments, the airbox outlet 38 is disposed in the airbox body 56, while in other embodiments the airbox outlet 38 is located in the airbox cover 58.

To prevent egress of pieces of debris from the airbox 34 through walls of the airbox body 56 and/or the airbox cover 58, one or more liner plates 60 are installed to one or more interior walls 62 of the airbox 34. In some embodiments, the liner plates 60 are formed from a metallic material such as steel. In other embodiments, the liner plates may be formed from an impact resistant fiber-reinforced composite material. The liner plates 60 are positioned and configured to prevent potential debris from the rotor 42 from exiting the airbox 34 through the walls of the airbox body 56 and/or the airbox cover 58. In some embodiments, the liner plates 60 are corrugated, having a plurality of ridges 67 arranged along a length of the liner plate 60, while in other embodiments, the profile of the liner plate 60 is smooth and continuous.

The liner plates 60 are secured to the interior walls 62 via, for example, a tab and slot arrangement, with a liner plate tab 64 of the liner plate 60 inserted into a complimentary slot 66 defined in the interior wall 62 of the airbox 34. In some embodiments, the slot and tab arrangements are located at two or more perimeter edges 68 of the liner plates 60 to ensure retention of the liner plates 60. While the slot and tab arrangement is described and illustrated herein, one skilled in the art will readily appreciate that in other embodiments, other features may be utilized to retain the liner plates 60, such as adhesives, rivets, screws or the like.

The airbox 34 including the liner plates 60 as disclosed herein provide an innovative configuration sufficient to bear the dynamic and impact loads of debris from the MTC 30. This structural improvement may be incorporated into existing airbox packaging, and does not interfere with operational requirements of the airbox 34 or the MTC 30. The configurations disclosed herein are manufacturable, adoptable, and applicable for existing air intake systems.

The terms “a” and “an” do not denote a limitation of quantity, but rather denote the presence of at least one of the referenced item. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

The term “about” is intended to include the degree of error associated with measurement of the particular quantity based upon the equipment available at the time of filing the application. For example, “about” can include a range of +8% of a given value.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An airbox for a fuel cell system, comprising:
an airbox body having an airbox inlet and an airbox outlet disposed therein, the airbox body including at least one interior wall;
an airbox cover installed to the airbox body to enclose the airbox; and
one or more liner plates installed onto the at least one interior wall to prevent egress of debris from an interior of the airbox to an exterior of the airbox through the at least one interior wall.

2. The airbox of claim 1, wherein the one or more liner plates are formed from a metallic material.

3. The airbox of claim 2, wherein the metallic material is corrugated.

4. The airbox of claim 1, wherein the one or more liner plates are secured to the at least one interior wall via a tab and slot arrangement.

5. The airbox of claim 1, wherein at least one liner plate is installed to each of the airbox body and the airbox cover.

6. The airbox of claim 1, wherein one or more of the airbox body and the airbox cover are formed from a plastic material.

7. A fuel cell system comprising:
a fuel cell stack containing at least one fuel cell; and
a motorized turbocharger compressor (MTC) system fluidly connected to the fuel cell stack to provide airflow for operation of the fuel cell stack, the MTC system including:
a compressor housing including an air inlet and a compressed air outlet;
a rotor disposed in the compressor housing and driven to rotate about a rotor axis, the rotor including a plurality of rotor blades;
an airbox including an airbox inlet and an airbox outlet, the airbox outlet connected to the air inlet via one or more airflow conduits; and
one or more liner plates installed onto at least one interior wall of the airbox to prevent egress of debris from an interior of the airbox to an exterior of the airbox through the at least one interior wall.

8. The fuel cell system of claim 7, wherein the airbox includes:
an airbox body; and
an airbox cover installed to the airbox body to enclose the airbox.

9. The fuel cell system of claim 8, wherein the one or more liner plates are installed to at least one of the airbox body and the airbox cover.

10. The fuel cell system of claim 8, wherein at least one liner plate is installed to each of the airbox body and the airbox cover.

11. The fuel cell system of claim 7, wherein the one or more liner plates are formed from a metallic material.

12. The fuel cell system of claim 11, wherein the metallic material is corrugated.

13. The fuel cell system of claim 7, wherein the one or more liner plates are secured to the at least one interior wall via a tab and slot arrangement.

14. A vehicle, comprising:
a vehicle body; and
a fuel cell system disposed in the vehicle body configured to provide power to one or more vehicle components, the fuel cell system including:
a fuel cell stack containing at least one fuel cell; and
a motorized turbocharger compressor (MTC) system fluidly connected to the fuel cell stack to provide airflow for operation of the fuel cell stack, the MTC system including:
a compressor housing including an air inlet and a compressed air outlet;
a rotor disposed in the compressor housing and driven to rotate about a rotor axis, the rotor including a plurality of rotor blades;
an airbox including an airbox inlet and an airbox outlet, the airbox outlet connected to the air inlet via one or more airflow conduits; and
one or more liner plates installed onto at least one interior wall of the airbox to prevent egress of debris from an interior of the airbox to an exterior of the airbox through the at least one interior wall.

15. The vehicle of claim 14, wherein the airbox includes:
an airbox body; and
an airbox cover installed to the airbox body to enclose the airbox.

16. The vehicle of claim 15, wherein the one or more liner plates are installed to at least one of the airbox body and the airbox cover.

17. The vehicle of claim 15, wherein at least one liner plate is installed to each of the airbox body and the airbox cover.

18. The vehicle of claim 14, wherein the one or more liner plates are formed from a metallic material.

19. The vehicle of claim 18, wherein the metallic material is corrugated.

20. The vehicle of claim 14, wherein the one or more liner plates are secured to the at least one interior wall via a tab and slot arrangement.
